(19) United States
(12) Patent Application Publication
(10) Pub. No.: US 2017/0193634 A1
(43) Pub. Date: Jul. 6, 2017

(54) DISPLAY SYSTEM FOR VEHICLE

(71) Applicant: SAMSUNG DISPLAY CO., LTD., Yongin-si (KR)

(72) Inventors: Mugyeom KIM, Yongin-si (KR); Kinyeng KANG, Yongin-si (KR)

(21) Appl. No.: 15/221,632

(22) Filed: Jul. 28, 2016

(30) Foreign Application Priority Data
Dec. 30, 2015 (KR) 10-2015-0189832

(51) Int. Cl. G06T 3/40; B60R 1/00; G06F 3/0484; G06F 3/0488; G06T 11/60; G06T 3/20

(52) U.S. Cl. CPC G06T 3/40; G06T 11/60; G06T 3/20; G06F 3/04845; G06F 3/0488; B60R 1/00

(57) ABSTRACT

A display system for a vehicle includes a display, a driver, a detector, and a display controller. The display is inside the vehicle to display one or more information. The driver drives the display to move the display. The detector detects a change of a provided region corresponding to an area recognized by a user as the display is moved by the driver. The display controller converts a shape of an information region in the display depending on the change of the provided region detected by the detector.

### CROSS-REFERENCE TO RELATED APPLICATION

Korean Patent Application No. 10-2015-0189832, filed on Dec. 30, 2015, and entitled, “Display System for Vehicle,” is incorporated by reference herein in its entirety.

### BACKGROUND

1. Field

One or more embodiments relate to a control system of a display for a vehicle.

2. Description of the Related Art

Various types of flat panel displays have been developed. These displays tend to be lighter in weight and thinner compared to more traditional types of displays. Recently, vehicles are being manufactured to include displays. However, these displays have proven to be inconvenient to use and pose a safety risk to drivers.

### SUMMARY

In accordance with one or more embodiments, a display system for a vehicle includes a display inside the vehicle to display one or more information; a driver to drive the display to move the display; a detector to detect a change of a provided region corresponding to an area recognized by a user as the display is moved by the driver; and a display controller to convert a shape of an information region in the display depending on the change of the provided region detected by the detector.

At least one region of the display may be received in one area inside the vehicle, and the display may move in a direction facing outside from inside the area inside the vehicle or a direction facing inside from outside of the area. The area may include a dashboard. The driver may include a velocity related controller to drive the display depending on a driving velocity of the vehicle. The driver may include a selective input controller to drive the display by recognizing a user selection input.

The detector may include a detector to detect the provided region based on driving information from the driver. The detector may include a detector to detect the provided region based on a reference point of the display or based on a comparison point adjacent to the reference point. The display controller may include a converter to convert a size of the information region on the display. The display controller may include a converter to convert a shape of the information region on the display.

In accordance with one or more other embodiments, a display system for a vehicle includes a display disposed inside the vehicle to display at least a first information region; a recognition controller to recognize a user manipulation for the first information region on the display; a conversion controller to convert the first information region to a second information region depending on recognition of the recognition controller; a location controller to determine a second information region display location to display the second information region; and a conversion display controller to display the second information region at the second information region display location.

The recognition controller may include a direction manipulation recognizer to recognize a direction of manipulation at the display based on a user manipulation for the first information region. The recognition controller may include a multi-manipulation recognizer to recognize user multi-manipulation for the first information region.

The conversion controller may generate the second information region to have a shape corresponding to one of divided first information regions, when converting the first information region to the second information region.

The location controller may determine the second information region display location to correspond to a direction of the user manipulation.

The display may create and display an additional information region separated from the second information region. Information of the first information region and the second information region may include same content or a same type of content.

In accordance with one or more other embodiments, a display device for a vehicle includes a display inside the vehicle to display an image; an image information controller to receive image information from inside the vehicle or an external capturing source; a location controller to define the display as a plurality of divided regions to display the image information on the display; and a display controller to allow the image information to match a divided region of the display and display the image information.

The display controller may include a location matcher to allow the image information received from the image information controller to match and correspond to the divided region of the display divided by the location controller; and a shape matcher to convert a shape of the image information to correspond to the divided region when displaying the image information according to the location matcher. The display controller may include an overlapping controller to display one or more image information to overlaps other image information. The overlapping controller may display one main image information to correspond to divided regions and display sub-image information to overlap the main image information that is less than the main image information.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display system for a vehicle;

FIG. 2 illustrates an embodiment of a display driver;

FIG. 3 illustrates another embodiment of a display driver;

FIG. 4 illustrates an embodiment of a region determination member;

FIG. 5 illustrates an embodiment of a display controller;

FIG. 6 illustrates an embodiment of a display system for a vehicle;

FIG. 7 illustrates another view of the display system in FIG. 6;

FIGS. 8A and 8B illustrate example operations of the display system, and FIG. 8C illustrates a modified example of FIG. 8B;

FIG. 9 illustrates a modified example of the display system;

FIG. 10 illustrates another embodiment of a display system for a vehicle;

FIG. 11 illustrates an embodiment of a user manipulation recognition controller;

FIG. 12 illustrates an embodiment of a conversion controller;

FIG. 13 illustrates an embodiment of a location controller;

FIG. 14 illustrates an embodiment of a conversion display controller;

FIG. 15 illustrates a view explaining the display system in FIG. 10;

FIGS. 16A to 16D illustrate example operations of the display system;

FIGS. 17A to 17C illustrate example operations of the display system;

FIG. 18 illustrates another embodiment of a display system for a vehicle;

FIG. 19 illustrates an embodiment of a display controller;

FIG. 20 illustrates another view of the display system in FIG. 18;

FIG. 21 illustrates another view of the display system; and

FIGS. 22A and 22B illustrate example operations of the display system.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

In the drawings, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

When an element is referred to as being “connected” or “coupled” to another element, it can be directly connected or coupled to the another element or be indirectly connected or coupled to the another element with one or more intervening elements interposed therebetween. In addition, when an element is referred to as “including” a component, this indicates that the element may further include another component instead of excluding another component unless there is different disclosure.

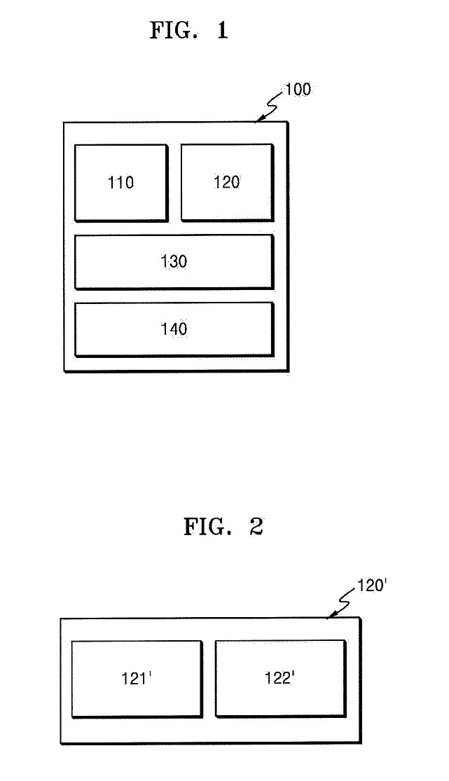

FIG. 1 illustrates an embodiment of a display system 100 for a vehicle. Referring to FIG. 1, the display system 100 includes a display 110, a driver 120, a provided region detector 130, and a display controller 140. The display 110 may display one or more types of information and may be inside a vehicle. Also, as a specific example, the display 110 may be in a dashboard among members inside the vehicle. In another embodiment, the display 110 may be at another location inside the vehicle.

According to an embodiment, the display 110 may be disposed such that at least one region of the display 110 may be received in a member inside the vehicle, for example, inside the dashboard. The display 110 may be moved by a driver 120, for example, in a direction facing outside from the inside of the dashboard.

According to an embodiment, the display 110 may display information related to driving of the vehicle. For example, the display 110 may display dashboard information indicating vehicle driving speed, engine revolutions, and/or remaining fuel.

According to an embodiment, the display 110 may cooperate with a mobile apparatus of a vehicle driver. In this case, the display 110 may display received information of the mobile apparatus, for example, a received call, and whether a received short message occurs, and display a received short message.

The display 110 may include one or more display components generating visual light. For example, the display 110 may include an organic light-emitting diode or a liquid crystal device. In another embodiment, the display 110 may selectively use various kinds of display components, e.g., an electric field light-emitting device, a plasma device, and/or a cathode ray tube. Also, according to an embodiment, the display 110 may receive a user input signal, e.g., a touch, a dragging, and/or a click.

The driver 120 drives the display 110, for example, such that the display 110 moves in one direction. According to another embodiment, the driver 120 may drive the display 110 such that the display 110 moves in one direction or an opposite direction. The driver 120 may include various members for driving the display 110. For example, the driver 120 may include a driving motor and a hydraulic member. In one embodiment, the driver 120 may drive the display 110 by including a pressure member.

The driver 120 may be inside the vehicle. According to an embodiment, one region of the display 110 may be inside the dashboard. The driver 120 may drive the display 110 such that the display 110 moves in a direction facing outside from the inside of the dashboard and moves in a direction facing inside the dashboard from the outside, which is an opposite direction. Inside of the dashboard may, for example, denote a region not visible to a vehicle passenger such as the vehicle driver.

The provided region detector 130 may detect a provided region proportional to the area which the display 110 provides to a user. Also, according to an embodiment, the provided region detector 130 may detect the changing size of the provided region. The “provided region” may denote a display region for the user's recognition provided by the display 110, and in at least one embodiment may correspond to a region recognizable by a user from among regions of the display 110.

For example, since the display 110 is driven by the driver 120, the region recognizable by the user (e.g., the provided region) may change and the provided region detector 130 may detect the change of the provided region.

According to an embodiment, when the display 110 moves in the direction facing outside from the inside of the dashboard, or moves in a direction facing inside the dashboard from outside, which is the opposite direction, via the driver 120, the user may recognize the provided region as a region excluding a region corresponding to inside the dashboard, e.g., a region corresponding to outside the dashboard from among the regions of the display 110.

Various methods may be used by the provided region detector 130 to detect the provided region. According to an embodiment, the provided region detector 130 may use information used by the driver 120 to drive the display 110. For example, the provided region detector 130 may receive drive information which the driver 120 used to drive the display 110 and may recognize the provided region of the display 110 using information indicative of a distance by which the display 110 has been moved by the driver 120.

According to an embodiment, the driver 120 may drive the display 110 in one direction and detect whether the display 110 reaches a limit point of the driving in one direction. A limit member may be disposed separately from the driver 120. The provided region detector 130 may detect when the display 110 reaches the limit member.

According to an embodiment, the provided region detector 130 may detect movement of a reference point of the display 110. For example, when the display 110 moves via the driver 120, the reference point of the display 110 moves and the provided region detector 130 may detect the provided region and a size change of the provided region by detecting the reference point. The reference point may be various points, e.g., may be an edge of the upper portion or the lower portion of the display 110. The reference point may be a point corresponding to an outermost edge with respect to a movement direction of the display 110. Also, for another example, the reference point may be a point of a region, not the edge of the display 110.

According to an embodiment, the provided region detector 130 may detect the size of the provided region by comparing the reference point of the display 110 with a comparison point of a region adjacent to the display 110 from among a region of a member inside the vehicle, for example, the region of the dashboard in which the display 110 is disposed.

The display controller 140 may convert a first information region displayed by the display 110 to a second information region corresponding to the first information region. For example, the display controller 140 may convert the first information region to the second information region when a size of the provided region reaches a first conversion set condition based on detection information of the provided region recognized by the provided region detector 130. Also, the display controller 140 may convert the second information region to the first information region when a size of the provided region reaches a second conversion set condition based on detection information of the provided region recognized by the provided region detector 130.

In one embodiment, the display 110 may display the first information region and may be moved in one direction by the driver 120. By this, the provided region of the display 110 may change, e.g., the provided region may be reduced. The provided region detector 130 may recognize this reduction. When the degree of the reduction reaches a predetermined condition (e.g., the first conversion set condition), the display controller 140 may convert the first information region to the second information region and display the second information region.

Also, the display 110 may be moved in a direction opposite to the one direction by the driver 120 again. By this, the provided region of the display 110 may change, e.g., the provided region may be increased. The provided region detector 130 may recognize this increase. When the degree of the increase reaches a predetermined condition (e.g., the second conversion set condition), the display controller 140 may convert the second information region to the first information region and display the first information region.

According to an embodiment, during conversion from the first information region to the second information region, the type of the first information region and the type of the second information region may be different from each other, and content of the information may not change. Also, the kind of information may not change and specific content may change. For example, both the first information region and the second information region may include information of a vehicle driving velocity.

According to an embodiment, the type and information content of the first information region and the second information region may change. The change of type from the first information region to the second information region may involve, for example, maintaining the shape and changing size. For example, the first information region may be converted to the second information region by reducing only size while maintaining the shape of the first information region. For example, conversion between the first information region and the second information region may involve a reduction or an increase.

FIG. 2 illustrates another embodiment of a display driver 120′ in FIG. 1. Referring to FIG. 2, the driver 120′ may include a velocity (or speed) related controller 121′ and a selective input controller 122′. In another embodiment, the driver 120′ may include the velocity related controller 121′ or the selective input controller 122′.

When the velocity of the vehicle corresponds to a set condition (which, for example, depends on the velocity of the vehicle), the velocity related controller 121′ may drive the display 110 and the display 110 may move. For example, when the velocity of the vehicle increases, the velocity related controller 121′ may allow the display 110 to move and the provided region to increase. Also, in contrast, when the velocity of the vehicle increases, the velocity related controller 121′ may allow the provided region to reduce. The velocity related controller 121′ may include a member for detecting the velocity of the vehicle and receiving information from a different member detecting the velocity. (In at least one embodiment, the term “velocity” may be understood as vehicle speed).

The selective input controller 122′ may recognize a user's selection input (e.g., driver selection input), e.g., may reflect the user's intention, and drive the display 110, thereby allowing the display 110 to move.

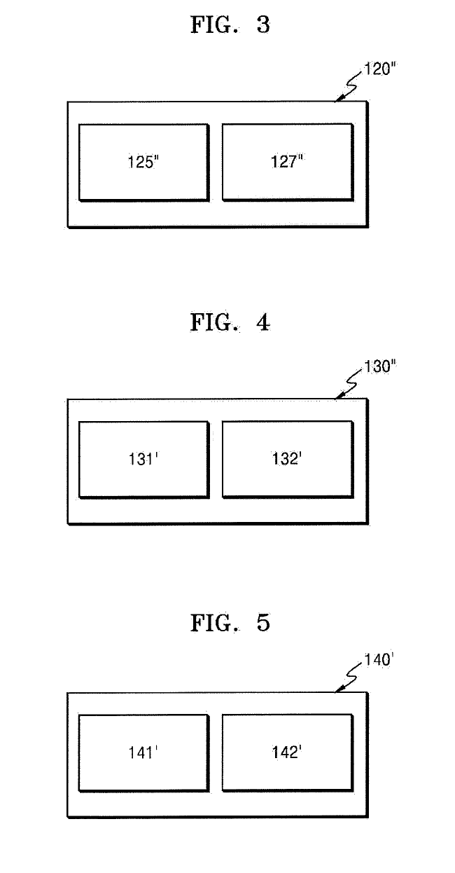

FIG. 3 illustrates another embodiment of a display driver 120″ which may include a condition setting unit 125″ and a determination controller 127″. The condition setting unit 125″ may set a “set vehicle velocity condition”. The condition setting unit 125″ may set a set vehicle velocity condition by receiving a user input and arbitrarily set the set vehicle velocity condition without a user input. When a new condition is input, the set vehicle velocity condition may be replaced by a new vehicle velocity condition.

The determination controller 127″ may determine whether the driving velocity of the vehicle corresponds to the “set vehicle velocity condition.” When the driving velocity of the vehicle corresponds to the “set vehicle velocity condition”, the determination controller 127″ may drive the display 110 and allow the display 110 to move.

FIG. 4 illustrates an embodiment of a region determination member 130′ in FIG. 1 which may include a driving determination unit 131′ and a location determination unit 132′. In another embodiment, the provided region detector 130′ may include the driving determination unit 131′ or the location determination unit 132′.

The driving determination unit 131′ may detect the provided region using driving information via the driver 120, 120′, or 120″. For example, the driving determination unit 131′ may receive the driving information which the driver 120, 120′, or 120″ uses to drive the display 110 and may detect the provided region or change of the provided region using the driving information.

According to an embodiment, the driving determination unit 131′ may detect whether the display 110 reaches a limit point of movement in one direction during movement of the display 110 and detect change of the provided region via this detection.

The location determination unit 132′ may detect change of the provided region by detecting movement of the reference point of the display 110 or comparing the reference point with a comparison point inside the vehicle adjacent to the display 110.

For example, when the display 110 moves, the reference point of the display 110 moves, and the location determination unit 132′ may detect the provided region and size change of the provided region by detecting the reference point. Also, the location determination unit 132′ may detect the size of the provided region by comparing the reference point of the display 110 with a comparison point of a region adjacent to the display 110 from among a region of a member inside the vehicle in which the display 110 is disposed, for example, the region of the dashboard.

FIG. 5 illustrates an embodiment of a display controller 140′ of FIG. 1 which may include a size conversion member 141′ and a shape conversion member 142′. In one embodiment, the display controller 140′ may include the size conversion member 141′ or the shape conversion member 142′.

In the case where the size of the provided region reaches a first conversion set condition, the size conversion member 141′ may convert the first information region to the second information region by reducing only size while including information content of the first information region and maintaining the shape of the first information region when converting the first information region into the second information region. Also, in the case where the size of the provided region reaches a second conversion set condition, the size conversion member 141′ may magnify only the size while including information content of the second information region and may maintain the shape of the second information region when converting the second information region into the first information region. For another example, the size conversion member 141′ may allow information content to differ during conversion from the first information region to the second information region and conversion from the second information region to the first information region.

In the case where the size of the provided region reaches the first conversion set condition, the shape conversion member 142′ may convert the first information region to the second information region by differing the shape of the first information region while including information content of the first information region.

Also, when converting the first information region to the second information region by changing the shape of the first information region, the size conversion member 142′ may generate the second information region in a shape suitable for the size of the provided region. In the case where the size of the provided region reaches the second conversion set condition, the size conversion member 142′ may generate the first information region in a shape different from the shape of the second information, while including information content of the second information region, when converting the second information region to the first information region. In another example, the size conversion member 142′ may allow information content to differ during conversion from the first information region to the second information region and conversion from the second information region to the first information region.

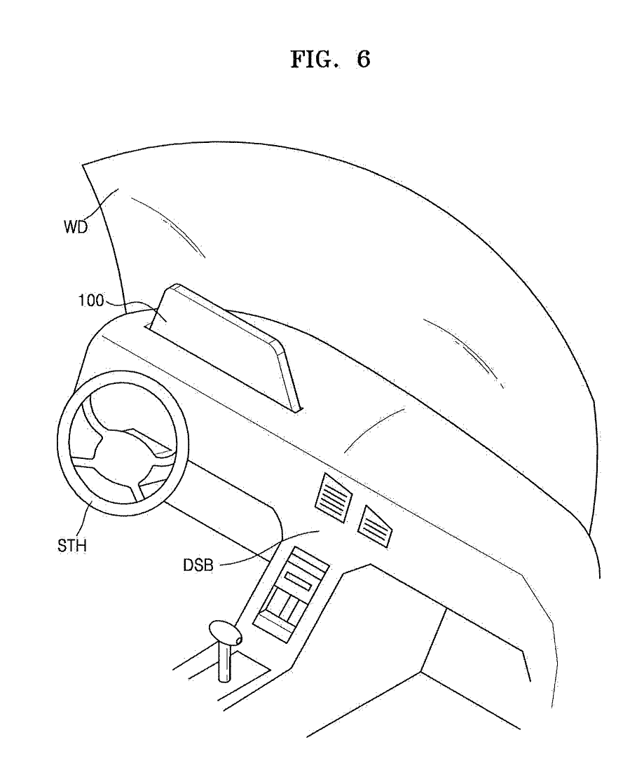

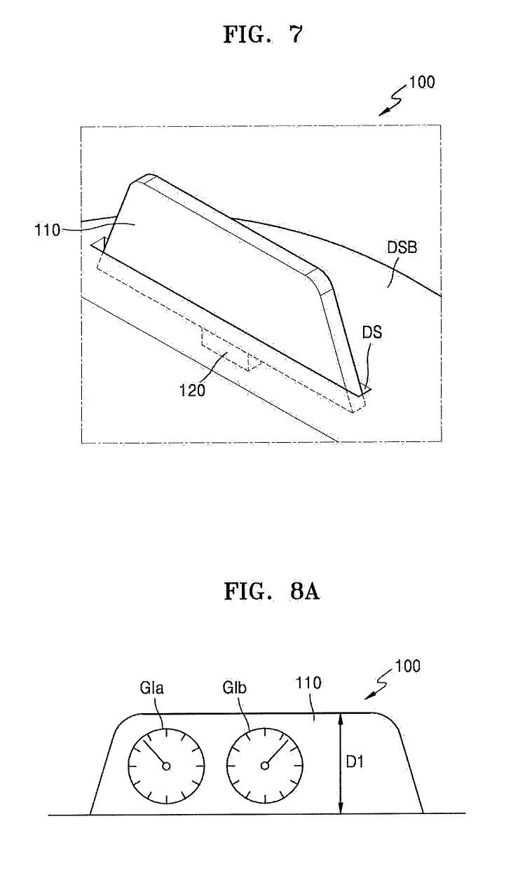

FIG. 6 illustrates another embodiment of a display system 100 for a vehicle of FIG. 1, and FIG. 7 is an enlarged view of the display system 100 in FIG. 6. Referring to FIGS. 6 and 7, the display system 100 for a vehicle may be inside the vehicle. For example, a steering wheel STH for a driver may be inside the vehicle and a front window WD may face the driver of the vehicle. According to an embodiment, the display system 100 for a vehicle may be in a dashboard DSB from among members inside the vehicle.

As illustrated in FIG. 7, the display 110 may pass through a groove DS of the dashboard DSB. The display 110 may move in a direction facing outside from the inside of the dashboard DSB, and move in a direction facing inside from outside the dashboard DSB, which is an opposite direction, via the driver 120. The groove DS of the dashboard DSB may have a width greater than a width of one direction of at least one region of the display 110, so that the display 110 may pass through the dashboard DSB and move. Also, a space connected with the groove DS may be inside the dashboard DSB so that the display 110 may move, and one region of the display 110 may be inside the dashboard DSB via the groove DS.

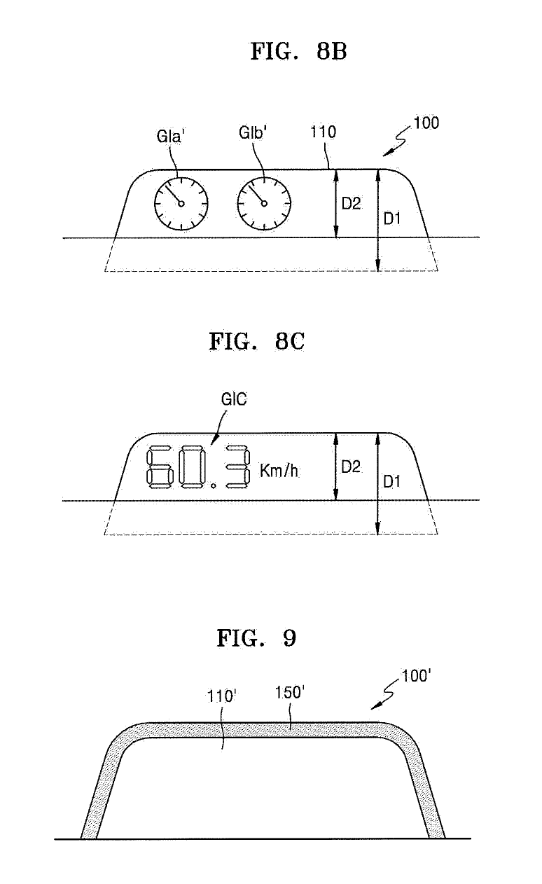

FIGS. 8A to 8C illustrate example operations of the display system 100 in FIG. 6. Referring to FIG. 8A, the display 110 of the display system 100 displays a first information region a “G1a” and a first information region b “G1b”. The display 110 has a height D1, which may correspond to a height of a region that is not inside the dashboard DSB but is outside the dashboard DSB, and thus is recognized by a user from among regions of the display 110. Also, the height D1 may correspond to the height of the “provided region.”

The first information region a “G1a” and the first information region b “G1b” may include various types of information, e.g., vehicle or driver related information according to an embodiment. For example, the first information region a “G1a” and the first information region b “G1b” may include dashboard information as vehicle driving related information.

Referring to FIG. 8B, the display 110 moves via the driver 120 (see, e.g., FIG. 7) and has a height D2. Compared with FIG. 8A, the display 110 moves in a direction facing inside the dashboard DSB and a height of a region that may be recognized by a user, e.g., a height of the “provided region” reduces from D1 to D2. The area of a region of the display 110 that may be recognized by the user may therefore be reduced.

The display 110 displays a second information region a “G1a′” and a second information region b “G1b′.” For example, the provided region detector 130 may detect a size change of the provided region, and the display controller 140 may convert the first information region a “G1a” and the first information region b “G1b” to the second information region a “G1a” and the second information region b “G1b”, respectively, and display the same.

The second information region a “G1a” and the second information region b “G1b” correspond to the first information region a “G1a” and the first information region b “G1b,” respectively. For example, the second information region a “G1a” and the second information region b “G1b” may maintain their shapes with only reduced size, while including the same information content of the first information region a “G1a” and the first information region b “G1b”.

FIG. 8C illustrates a modified example where the display 110 moves via the driver 120 (see, e.g., FIG. 7) and has a height D2. Compared with FIG. 8A, the display 110 moves in a direction facing inside the dashboard DSB and a height of a region that may be recognized by a user (e.g., a height of the “provided region”) reduces from D1 to D2. The area of a region of the display 110 that may be recognized by the user is therefore reduced.

The display 110 displays a second information region c “G1c.” For example, the provided region detector 130 may detect a size change of the provided region, and the display controller 140 may convert the first information region a “G1a” or the first information region b “G1b” to the second information region c “G1c” for display.

The second information region c “G1c” corresponds to the first information region a “G1a” or the first information region b “G1b.” For example, the second information region c “G1c” may change shape while including information content of the first information region a “G1a” or the first information region b “G1b.” For example, the second information region c “G1c” may be converted to a digital display dashboard shape including a text type image, instead of analog display dashboard having an instrument needle inside a circular shape, while including information content of the first information region a “G1a” or the first information region b “G1b.” The second information region c “G1c” may selectively convert the first information region a “G1a” or the first information region b “G1b.”

According to an embodiment, the second information region c “G1c,” converted from the first information region a “G1a” and the first information region b “G1b,” may be displayed on the display 110.

FIG. 9 illustrates a modified example of the display system 100′ for a vehicle of FIG. 6. Referring to FIG. 9, compared with the previous embodiment, a display system 100′ for a vehicle includes a light provider 150′ around a display 110′. The light provider 150′ may be at the edge of the display 110′ and may surround the edge of at least one side of the display 110′ according to an embodiment.

According to an embodiment, the light provider 150′ may be formed in a tube shape around the display 110′, and may contact the display 110′. The light provider 150′ may generate light of one or more colors. Also, the light provider 150′ may convert one color light to another color light. The light conversion may be arbitrarily performed according to a set period and may be performed according to a user's intention.

The display system 100′ includes a display inside the vehicle, so that a user of the vehicle (e.g., vehicle driver) may easily obtain information. The display may be driven by a driver. The size of the provided region, which is a region that may be recognized by a user, may change. The provided region detector may detect the change in size of the provided region. The display controller may convert the shape of an information region on the display depending on a change of the provided region. For example, the first information region may be converted to the second information region. Conversion from the first information region to the second information region may include changing shape while maintaining the same information or different information. Also, the size may change while the shape is maintained.

Thus, the display may move depending on a user convenience or a driving condition. Also, user convenience may be improved by displaying an information region corresponding to movement of the display.

According to an embodiment, the display may be allowed to move to the dashboard inside the vehicle and may move in the opposite direction. For example, when the velocity (or speed) of the vehicle exceeds a predetermined value, stability of the display and user safety (e.g., protection from an accident) may improve by reducing the region of the display that is exposed outside of the dashboard. Also, since various kinds and shapes of information regions are converted and displayed to a user via one display, the ability to recognize information may be improved.

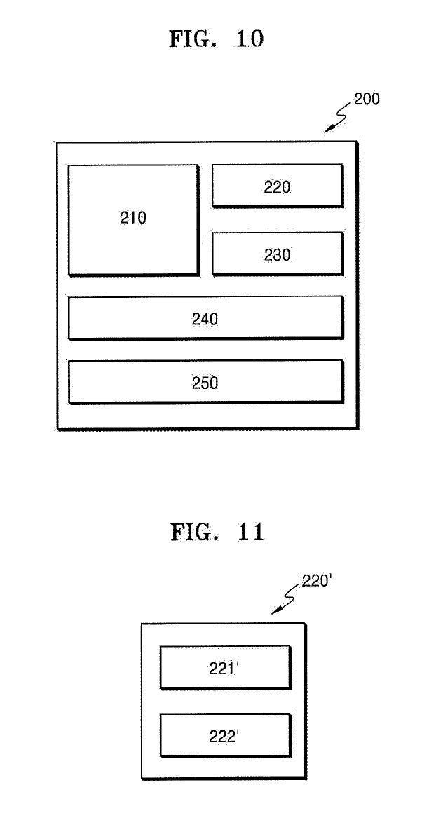

FIG. 10 illustrating another embodiment of a display system 200 for a vehicle. Referring to FIG. 10, the display system 200 includes a display 210, a user manipulation recognition controller 220, a conversion controller 230, a location controller 240, and a conversion display controller 250.

The display 210 may display one or more first information regions and may be inside a vehicle. Also, in one embodiment, the display 210 may be in a dashboard from among members inside the vehicle. According to an embodiment, the display 210 may be disposed such that at least one region of the display 210 is received inside a member inside the vehicle, for example, inside the dashboard. According to an embodiment, the display 210 may move in a direction facing the outside from the inside of the dashboard.

The display 210 may display a first information region including information related to driving of the vehicle. For example, the display 210 may display the first information region including dashboard information indicating a driving velocity of the vehicle, an engine revolution velocity, and/or a remaining fuel.

According to an embodiment, to cooperate with a vehicle driver's mobile apparatus, the display 210 may display the first information region including reception information of the mobile apparatus, for example, a received call, whether a received short message occurs, and/or received short message content.

The display 210 may include one or more display components generating visible light. For example, the display 210 may include an organic light-emitting diode or a liquid crystal device. In one embodiment, the display 210 may selectively use various types of display components, e.g., electric field light-emitting device, a plasma device, and/or a cathode ray tube.

According to an embodiment, the display 210 may receive a user input signal, e.g., a touch, dragging, click, or flicking signal. The user manipulation recognition controller 220 may recognize the user manipulation or user input signal for the display 210. As described above, the user may manipulate the display 210 and, for example, may input a touch, dragging, or click signal. The user manipulation recognition controller 220 may recognize the input.

According to an embodiment, the user manipulation recognition controller 220 may recognize a user's directional manipulation intending movement of the first information region of the display 210 toward one direction. For example, when a user performs a dragging or flicking operation on the display 210 in one direction, the user manipulation recognition controller 220 may recognize the manipulation. Also, the user manipulation recognition controller 220 may recognize a specific direction of the dragging or flicking. In this case, the user's finger, etc., may directly contact the first information region and may be spaced apart from the first information region and indicate only a direction. For example, the user's finger may indicate only a movement direction of the first information region.

According to an embodiment, the user manipulation recognition controller 220 may recognize a user's multi-manipulation for the first information region of the display 210. The multi-manipulation may include a multi-touch, a multi-dragging, or a multi-flicking operation. For example, a user may drag the first information region displayed on the display 210 to the left side using one of two fingers, and drag the second information region displayed on the display 210 to the left side using the other of the two fingers. The user manipulation recognition controller 220 may recognize the two directional dragging or flicking operations.

The conversion controller 230 may convert the first information region to the second information region depending on a result recognized by the user manipulation recognition controller 220.

The second information region may include information content of the first information region without change or may include changed information content of the first information region. The second information region may include the same kind of information as information of the first information region. For example, the first information region and the second information region may include a driving vehicle velocity changing in real-time.

In one embodiment, the second information region may be different from the first information region in form. For example, the second information region may be different from the first information region in shape and/or size. According to an embodiment, the second information region may have the same shape as a portion of the first information region and may reduce (or magnify) the shape of the portion of the first information region. According to an embodiment, the second information region may include a plurality of regions that divide the first information region.

The location controller 240 may determine a location for displaying the second information region converted by the conversion controller 230 from among regions of the display 210. For example, the second information region display location may be a location at which the second information region is disposed inside the display 210.

In one embodiment, the location controller 240 may determine the second information region display location from among the regions of the display 210 based on information recognized by the user manipulation recognition controller 220. For example, a user manipulation recognized by the user manipulation recognition controller 220 may be recognized. Through the user manipulation recognition information, the location controller 240 may determine the second information region display location as a place inside the display 210 that corresponds to a direction in which a user intends to move the first information region.

In one example, the location controller 240 may use a user manipulation in one direction detected by the user manipulation recognition controller 220 (e.g., a dragging or flicking in one direction) and may determine a region corresponding to an end point of the manipulation in one direction as the second information region display location.

In another example, the location controller 240 may determine the second information region display location as a region adjacent to an end point of the manipulation in one direction or facing the end point.

In another example, in detecting the manipulation in one direction, the location controller 240 may determine the second information region display location as a region set in advance to correspond to the manipulation in one direction.

The second information region display location may be different from a location at which the first information region is displayed. According to an embodiment, the second information region display location may partially overlap a location at which the first information region is displayed.

The conversion display controller 250 may dispose the second information region at the second information region display location determined by the location controller 240 from among the regions of the display 210 for display. The conversion display controller 250 may display the second information region without change at the second information region display location determined by the location controller 240 from among the regions of the display 210.

According to an embodiment, the conversion display controller 250 may partially change the form of the second information region such that the second information region is suitable for the second information region display location for display. For example, when the second information region display location is adjacent to an edge from among the regions of the display 210, the conversion display controller 250 may partially change the second information region such that the second information region is suitable for the form of the edge for display. After the second information region is finally converted first by the conversion controller 230, the converted second information region may be displayed.

According to an embodiment, the conversion display controller 250 may create and display a second information region and a new additional information region. For example, the conversion display controller 250 may create and display the additional information region at the location at which the first information region has been displayed.

FIG. 11 illustrates an embodiment of a user manipulation recognition controller 220′ of FIG. 10. The user manipulation recognition controller 220′ may include a direction manipulation recognizer 221′ and a multi-manipulation recognizer 222′. In one embodiment, the user manipulation recognition controller 220′ may include the direction manipulation recognizer 221′ or the multi-manipulation recognizer 222′.

When a user manipulation for the first information region displayed on the display 210 exists, the direction manipulation recognizer 221′ may recognize the direction of the manipulation and a start point and an end point of the manipulation. For example, when a touch, a dragging, or a flicking movement occurs in the first information region displayed on the display 210, the direction manipulation recognizer 221′ may recognize the direction of the manipulation. For example, when a dragging or flicking or touching to the left exists as a manipulation intending to move the first information region displayed on the display 210 to a region adjacent to a left edge of the display 210, the direction manipulation recognizer 221′ may recognize the left direction inside the display 210 as a user's intended direction.

The multi-manipulation recognizer 222′ may recognize a user's multi-manipulation for the first information region of the display 210. The multi-manipulation may include a multi-touch, a multi-dragging, or a multi-flicking movement. For example, a user may drag the first information region displayed on the display 210 to the left using one of two fingers and may drag the first information region displayed on the display 210 to the right using the other of the two fingers. The multi-manipulation recognizer 222′ may recognize dragging in the left direction and the right direction.

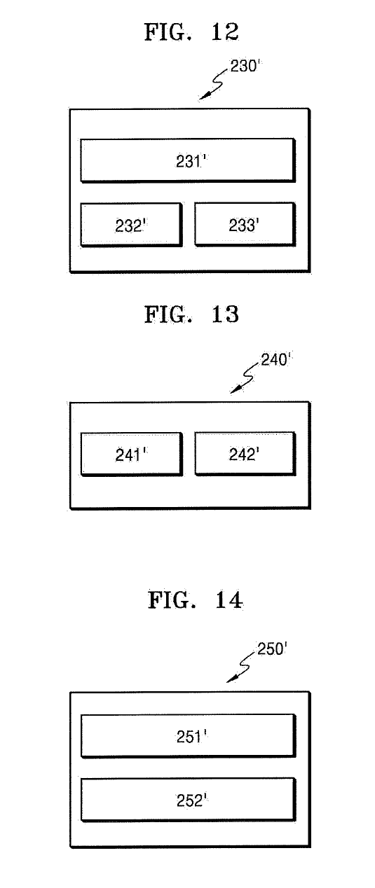

FIG. 12 illustrates an embodiment of a conversion controller 230′ in FIG. 10 which may include a setting converter 231′, a shape converter 232′, and a size converter 233′. In one embodiment, the conversion controller 230′ may include only the setting converter 231′. Also, in one embodiment, the conversion controller 230′ may include the shape converter 232′ and/or the shape converter 232′ and the size converter 233′.

The setting converter 231′ may convert the first information region to the second information region depending on a condition corresponding to a result recognized by the user manipulation recognition controller 220 or 220′ from among conditions set in advance. For example, when a result recognized by the user manipulation recognition controller 220 or 220′ is left or right (e.g., a dragging, touch, or flicking) in a direction facing the edge of the display, the setting converter 231′ may divide the first information region and generate the second information region in a form corresponding to one of the divided first information regions.

The shape converter 232′ may convert the shape of the first information region and generate the second information region. For example, when the shape of the first information region is a circle, the second information region may be a part of the circle, e.g., a part of a sector.

The size converter 233′ may generate the second information region to have a size different from the size of the first information region when generating the second information region.

FIG. 13 illustrates an embodiment of a location controller 240′ in FIG. 10 which includes an input determination unit 241′ and a setting location unit 242′. In another embodiment, the location controller 240′ may include the input determination unit 241′ or the setting location unit 242′.

The input determination unit 241′ may determine a location depending on recognition of a user manipulation. For example, the input determination unit 241′ may determine a second information region display location depending on information recognized by the user manipulation recognition controller 220 or 220′. For example, the input determination unit 241′ may receive a user manipulation in one direction detected by the user manipulation recognition controller 220, for example, a result of detecting a dragging, touching, or flicking in one direction, and information of an end point of the manipulation in the one direction, and may determine a region corresponding thereto as the second information region display location. Also, in another example, the input determination unit 241′ may determine a region adjacent to an end point of the manipulation in the one direction or facing the end point as the second information region display location.

When the user manipulation recognition controller 220 or 220′ detects a user manipulation in one direction, the setting location unit 242′ may determine the second information region display location as a region set in advance to correspond to the user manipulation in one direction. For example, the setting location unit 242′ may determine the second information region display location without accurate information of a start point and an end point of a manipulation in one direction. For example, when the user manipulation recognition controller 220 or 220′ detects a user's dragging from the center of the display 210 to the left, the setting location unit 242′ may determine a region including the left edge of the display 210 as the second information region display location without information of an angle of an accurate direction of the dragging, a length of the dragging, etc.

FIG. 14 illustrates an embodiment of a conversion display controller 250′ of FIG. 10 which may include a second information region display 251′ and an additional information region display 252′. The second information region display 251′ may dispose and display the second information region at the second information region display location determined by the location controller 240 or 240′ from among the regions of the display 210.

The second information region display 251′ may display the second information region without change at the second information region display location from among the regions of the display 210. According to an embodiment, the second information region display 251′ may partially change the shape of the second information region to be suitable for the second information region display location for display. For example, when the second information region display location is a region adjacent to an edge from among the regions of the display 210 and the shape of the edge has a curve, the second information region corresponding to the edge may be partially changed to have a curved edge.

The additional information region display 252′ may create a new separate additional information region separated from the second information region and display the same.

According to an embodiment, the second information region may be displayed at the second information region display location. For example, the second information region may be displayed at a region adjacent an edge away from the center of the display 210 by the second information region display 251′. The additional information region display 252′ may create and display an additional information region in a region including a central region of the display 210.

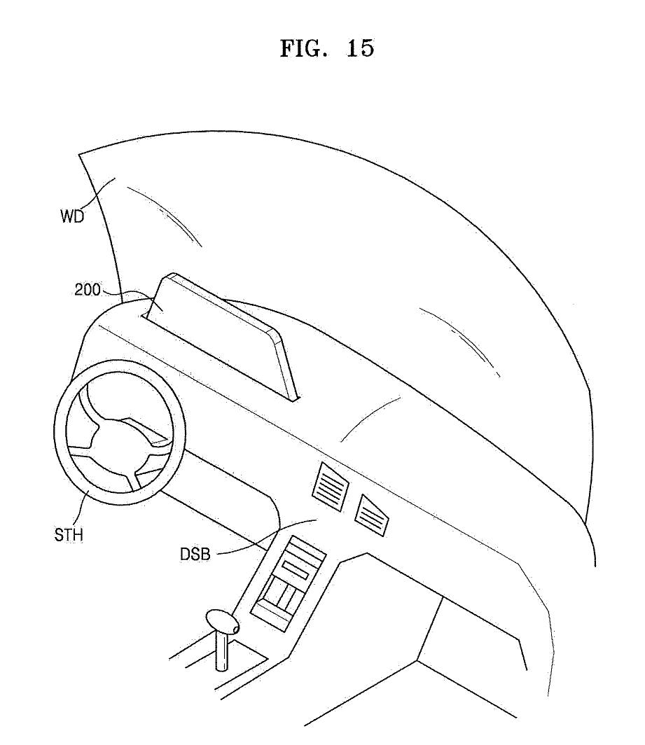

FIG. 15 illustrates an example operation of a display system 200 for a vehicle of FIG. 10. Referring to FIG. 15, the display system 200 may be disposed inside the vehicle. For example, a steering wheel STH for a driver may be inside the vehicle and a front window WD may face the driver of the vehicle.

According to an embodiment, the display system 200 may be in a dashboard DSB from among members inside the vehicle. According to an embodiment, the display 210 may pass through a groove DS of the dashboard DSB. According to an embodiment, the display 210 may move in a direction facing outside from inside the dashboard DSB, and move in a direction facing inside from outside the dashboard DSB, which is an opposite direction, via the driver.

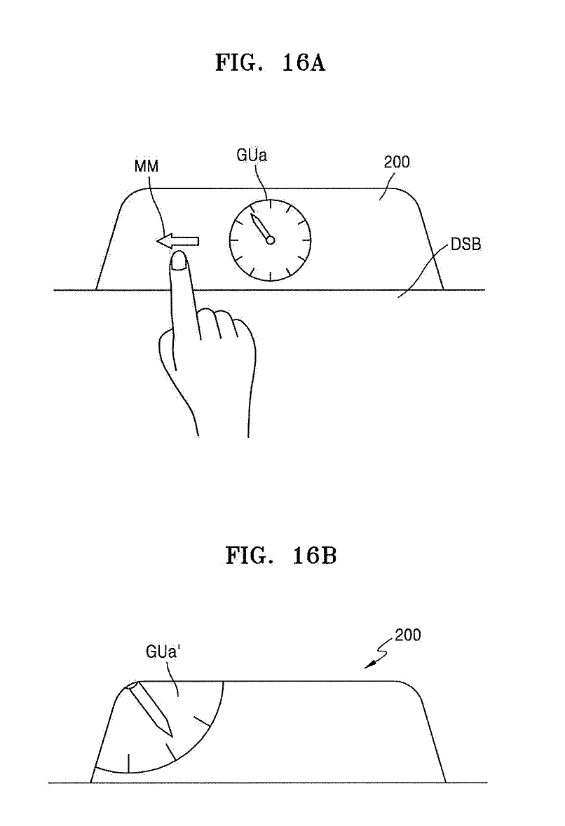

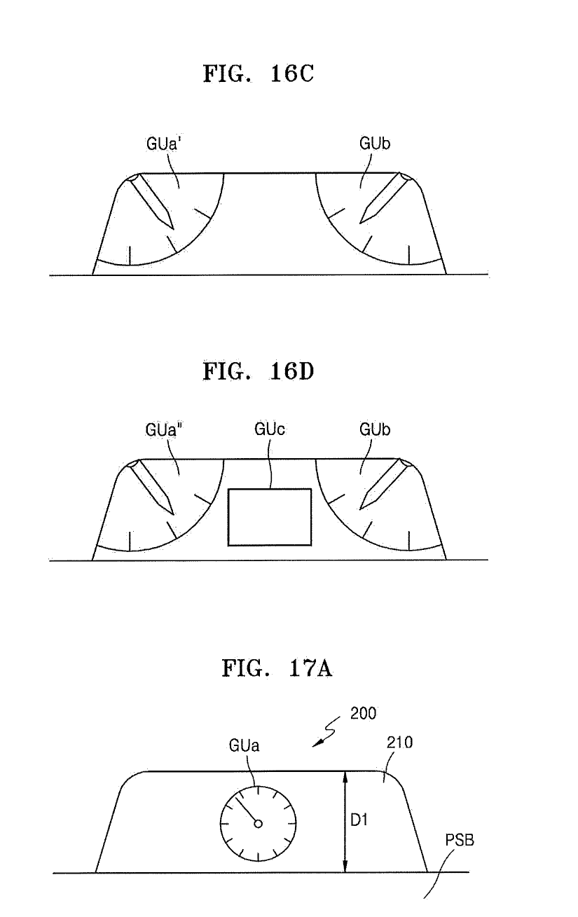

FIGS. 16A to 16D are views for explaining operations of the display system 200 for a vehicle of FIG. 10. Referring to FIG. 16A, the display 210 of the display system 200 for a vehicle displays a first information region GUa. The first information region GUa may include various types of information, e.g., vehicle or driver related information. For example, the first information region GUa may include dashboard information as vehicle driving related information. In FIG. 16A, a user drags in one direction MM, e.g., a direction from the central region of the display 210 to the left edge of the display 210. This may be considered as a direction intending movement of the display 210. Such a user dragging operation may be recognized by the user manipulation recognition controller 220 or 220′.

Referring to FIG. 16B, the display 210 may convert the first information region GUa to a second information region GUa′ for display. For example, the second information region GUa′ may be converted by the conversion controller 230 or 230′. The location controller 240 or 240′ may determine the second information region display location as a region adjacent to the left edge of the display 210. Accordingly, the conversion display controller 250 or 250′ may display the second information region GUa′.

Both the first information region GUa and the second information region GUa′ may include the same information content, and may selectively include a vehicle driving velocity meter, for example, as the same kind of information. The first information region GUa may maintain a circle and the second information region GUa′ may have a portion of a circle, for example, a sector shape corresponding to the edge of display 210.

In this case, to maintain the same information or maintain the same kind of information, the central axis of a circular dashboard of the first information region GUa may be disposed at the edge of the second information region GUa′ in the second information region GUa′. Also, to maintain the same function as that of the first information region GUa, the second information region GUa′ may change a range or a unit of dashboard numbers.

Referring to FIG. 16C, the display 210 may display a new additional information region GUb when converting the first information region GUa to the second information region GUa′ for display. In this case, the additional information region GUb may be in a region facing the second information region GUa′.

The additional information region GUb may include new information.

According to an embodiment, when the first information region GUa is information that is divided into a plurality of information regions, the additional information region GUb is a converted region of the first information region GUa. For example, the first information region GUa may be divided and converted, so that the second information region GUa′ and the additional information region GUb may be displayed. Referring to FIG. 16D, the display 210 may display a new additional information region GUc in a region in which the first information region GUa has been displayed when converting the first information region GUa to the second information region GUa′ for display. In this case, the additional information region GUb may be selectively disposed in a region facing the second information region GUa′.

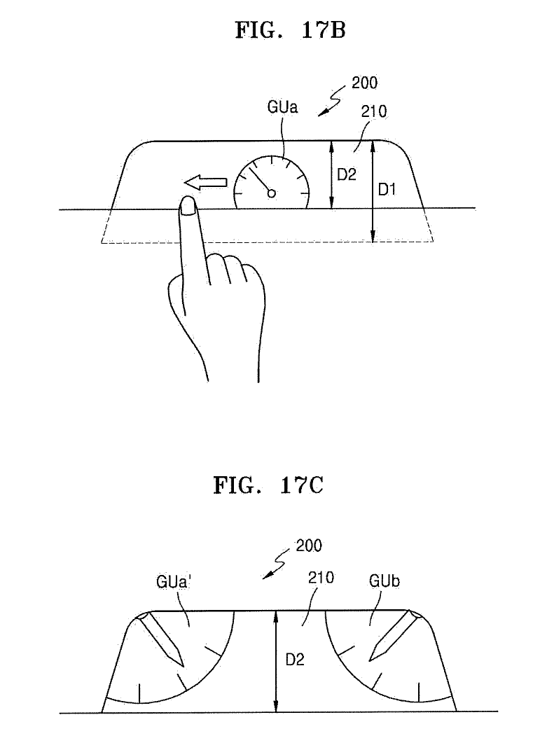

FIGS. 17A to 17C illustrate example operations of the display system 200 for a vehicle of FIG. 10. Referring to FIG. 17A, the display 210 displays the first information region GUa. The display 210 has a height D1, which may correspond to a height of a region not inside the dashboard DSB and outside the dashboard DSB, and thus recognized by a user from among the regions of the display 210.

Referring to FIG. 17B, the display 210 moves via a driver and has a height D2. Compared with FIG. 17A, the display 210 moves in a direction facing inside the dashboard DSB and a height of a region that may be recognized by a user reduces from D1 to D2. The area of a region of the display 210 may therefore be recognized by the user as being reduced.

In FIG. 17B, the user drags in a direction from the central region of the display 210 to the left edge of the display 210, which may be considered as a direction intending movement of the display 210. Such a user dragging may be recognized by the user manipulation recognition controller 220 or 220′.

After that, referring to FIG. 17C, the first information region GUa is converted to the second information region GUa′ and the converted second information region GUa′ is displayed. For example, the second information region GUa′ may be converted by the conversion controller 230 or 230′. The location controller 240 or 240′ may determine the second information region display location as a region adjacent to the left edge of the display 210. Accordingly, the conversion display controller 250 or 250′ may display the second information region GUa′.

According to an embodiment, the display 210 may display a new additional information region GUb when converting the first information region GUa to the second information region GUa′ for display. In this case, the additional information region GUb may be in a region facing the second information region GUa′.

In the display system 200, the display is inside the vehicle so that a vehicle user (e.g., a driver) may easily obtain information. The display may display the first information region, recognize a user manipulation for the display, convert the first information region to the second information region depending on this recognition, determine a second information display location for displaying the second information region, and then display the second information region at the second information region display location.

For example, the display may change the location of the first information region and move the first information region to the second information region according to the user's intention. Also, according to an embodiment, the display may form the second information region to include information which is same as or different from that of the first information region. In this case, the shape and/or size of the second information region may change depending on the location of the second information region.

Through this, the user's information recognition ability may improve. For example, a driver may move the first information region in a direction close to the driver in order to view the first information region in detail. Accordingly, the driver may easily pull driving related information (e.g., vehicle driving velocity) selectively and view the information via the converted second information region.

Also, a user on a passenger seat may pull the first information region including information irrelevant to the driver or not essentially required while driving (e.g., weather information or Internet information) in a direction adjacent to the passenger seat and view the information via the converted second information region. Through this, the user convenience and attention may be improved.

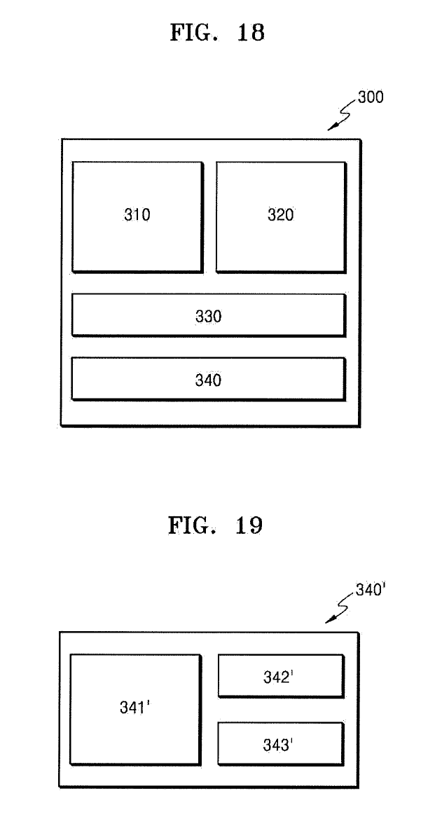

FIG. 18 illustrates another embodiment of a display system 300 for a vehicle which may include a display 310, an image information controller 320, a location controller 330, and a display controller 340. The display 310 displays one or more types of information and may be inside the vehicle. Also, in one embodiment, the display 310 may be in a dashboard from among members inside the vehicles. Also, according to an embodiment, the display 310 may be disposed such that at least one region of the display 310 is received inside a member inside the vehicle (e.g., inside the dashboard) and may move in a direction facing outside from inside the dashboard.

The display 310 may display information for an image that has captured the neighborhood of the vehicle, for example, a photo or a moving picture. Alternatively or additionally, the display 310 may display information related to driving of the vehicle, e.g., dashboard information indicating a driving velocity of the vehicle, an engine revolution velocity, and/or a remaining fuel.

According to an embodiment, to cooperate with a vehicle driver's mobile apparatus, the display 310 may display reception information of the mobile apparatus, e.g., a received call, whether a received short message occurs or display a received short message.

The display 310 may include one or more display components for generating light. For example, the display 310 may include an organic light-emitting diode or a liquid crystal device. In one embodiment, the display 310 may selectively use various kinds of display components, e.g., an electric field light-emitting device, a plasma device, and/or a cathode ray tube. Also, according to an embodiment, the display 310 may be formed to receive a user input, that is, various operations such as a touch, a dragging, and a click.

The image information controller 320 may receive image information from the inside of the vehicle or an external capturing member. The image information received by the image information controller 320 may be of various types. For example, the image information controller 320 may receive a rear image of the vehicle from a camera capturing an image of the rear of the vehicle.

In another example, the image information controller 320 may receive a front image of the vehicle from a camera capturing an image of the front of the vehicle, and receive a left or right image of the vehicle from a camera capturing the left neighborhood or right neighborhood of the vehicle.

In another example, the image information controller 320 may receive an image of inside the vehicle from a camera inside the vehicle.

The location controller 330 may divide the region of the display 310 into one or more divided regions in order to display one or more image information received from the image information controller 320 on the display 310. According to an embodiment, the location controller 330 may divide the region of the display 310 into a number of divided regions equal to or greater than a number of image information received from the image information controller 320. For example, when receiving a rear image, a front image, and a left neighborhood image of the vehicle from the image information controller 320, the location controller 330 may divide the display 310 into three divided regions including a central region, a left region, and a right region.

The display controller 340 may allow one or more image information received from the image information controller 320 to match the divided region of the display 310 divided by the location controller 330, and display the image information. For example, the display controller 340 may display the rear image of the vehicle on the central region of the display 310, display the front image of the vehicle on the right region of the display 310, and display the left neighborhood image of the vehicle on the left region of the display 310.

According to an embodiment, the display controller 340 may transform an image so that each image corresponds to the form of each divided region of display 310.

According to an embodiment, the display controller 340 may display one or more image information received from the image information controller 320 on the display 310 only in the case where a set condition is met. For example, the display controller 340 may display one or more image information received from the image information controller 320 on the display 310 only in the case where a driving velocity of the vehicle reduces and reaches a set condition. Also, for another example, the display controller 340 may display one or more image information received from the image information controller 320 on the display 310 only in the case where a driving velocity reduces or a rear gear operates for parking the vehicle.

FIG. 19 illustrates an embodiment of a display controller 340′ of FIG. 18 which may include a location matching unit 341′, a form matching unit 342′, and an overlapping controller 343′. In one embodiment, the display controller 340′ may include the location matching unit 341′ and omit the form matching unit 342′ and the overlapping controller 343′. In another embodiment, the display controller 340′ may include the location matching unit 341′ and the form matching unit 342′ and omit the overlapping controller 343′.

The location matching unit 341′ may allow one or more image information received from the image information controller 320 to match the divided regions of the display 310, such that each information corresponds to the divided region of the display 310 divided by the location controller 330. For example, when there are four divided regions listed in one direction from the left edge to the right edge inside the display 310, the location matching unit 341′ may allow a left neighborhood image, a front image, a rear image, and a right neighborhood image of the vehicle to sequentially match the divided regions, respectively, for display. Also, according to an embodiment, the location matching unit 341′ may allow one image information to correspond to a plurality of divided regions depending on cases.

The form matching unit 342′ may convert an image such that the image corresponds to the form of each divided region when displaying the image according to the location matching unit 341′. For example, all of the divided regions of the display 310 may not be in the same form, e.g., the all or a portion of the divided regions may be different. In one example, the forms of the divided regions corresponding to the central region and the edge region of the display 310 may be different. In another example, the forms of the divided regions may be different for each location. The form matching unit 342′ may reduce or magnify an image depending on the form of the divided region, and may perform an edge pattern process and image conversion processes suitable for other divided regions.

The overlapping controller 343′ may display one or more image information to overlap other image information. In this case, the one or more image information may be displayed as main information in the divided region, and the other image information may be displayed as sub information so that the other image information partially overlaps the main information in the divided region in which the main information has been displayed.

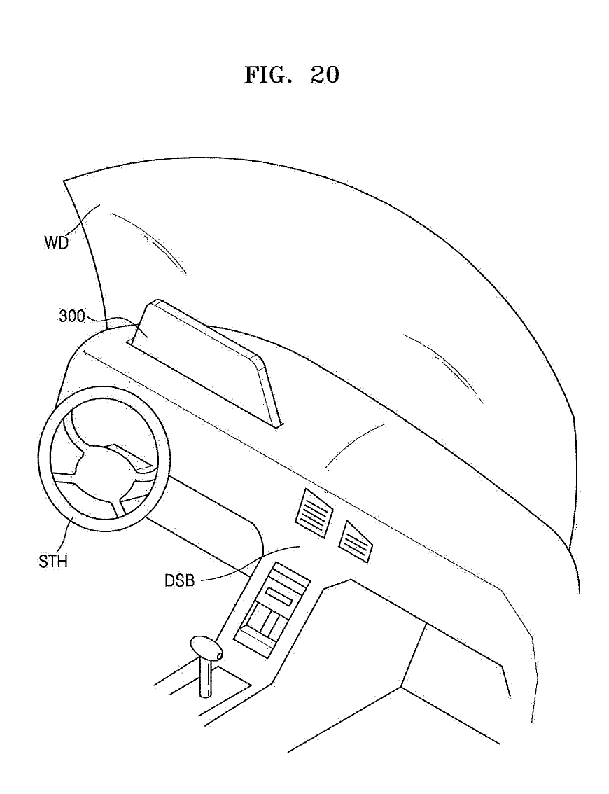

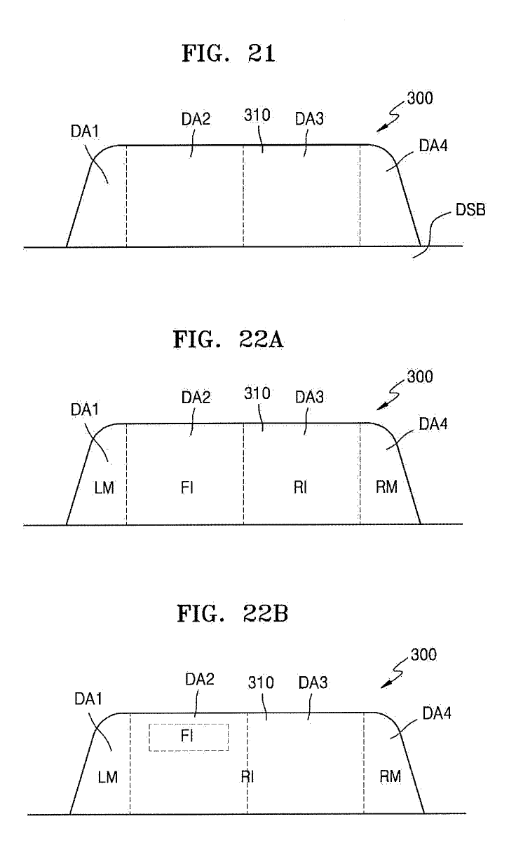

FIG. 20 illustrates example operations of the display system 300 in FIG. 18, and FIG. 21 is an enlarged view illustrating the display system 300 of FIG. 20. Referring to FIGS. 20 and 21, the display system 300 may be inside the vehicle. For example, a steering wheel STH for a driver may be inside the vehicle and a front window WD may face the driver of the vehicle. According to an embodiment, the display system 300 may be in a dashboard DSB from among members inside the vehicle.

As illustrated in FIGS. 20 and 21, a display 310 may pass through a groove DS of the dashboard DSB. According to an embodiment, the display 310 may move in a direction facing outside from inside of the dashboard DSB and may move in a direction facing inside from outside of the dashboard DSB, which is an opposite direction, via the driver.

FIG. 21 illustrates that a region of the display 310 is divided into one or more divided regions, so that one or more image information received from the image information controller 320 may be displayed on the display 310 by the location controller 330. For example, the region of the display 310 is divided into a first divided region DA1, a second divided region DA2, a third divided region DA3, and a fourth divided region DA4. The first divided region DA1, the second divided region DA2, the third divided region DA3, and the fourth divided region DA4 may be located side by side in a direction from left to right based on recognition of a user, for example, a driver of the vehicle.

The form of the display 310 may be various types. For example, as illustrated in FIG. 21, edges on respective sides may have an inclined plane. Thus, the first divided region DA1 and the fourth divided region DA4 may have a symmetric form. Also, the second divided region DA2 and the third divided region DA3 may have a symmetric form. In one embodiment, the display 310 may have a rectangular form. Also, in one embodiment, when the display 310 is divided, the divided regions may be divided to have different forms and divided in a curve or inclined boundary line, not a straight line.

FIGS. 22A and 22B illustrate example operations of the display system 300 of FIG. 18. Referring to FIG. 22A, the display system 300 is illustrated. The display 310 of the display system 300 is divided into a first divided region DA1, a second divided region DA2, a third divided region DA3, and a fourth divided region DA4 as illustrated in FIG. 21. In this case, boundary lines dividing the first divided region DA1, the second divided region DA2, the third divided region DA3, and the fourth divided region DA4 may be virtual lines, not lines actually dividing the display 310.

A left neighborhood image LM, a front image FI, a rear image RI, and a right image RM of the vehicle may be in the first divided region DA1, the second divided region DA2, the third divided region DA3, and the fourth divided region DA4.

The left neighborhood image LM, the front image FI, the rear image RI, and the right image RM of the vehicle may be information which the image information controller 320 receives from cameras capturing images of the left, right, front, and rear of the vehicle. The display controller 340 or 340′ may allow the left neighborhood image LM, the front image FI, the rear image RI, and the right image RM of the vehicle to match the first divided region DA1, the second divided region DA2, the third divided region DA3, and the fourth divided region DA4, for display.

According to an embodiment, the display controller 340 or 340′ may display the left neighborhood image LM, the front image FI, the rear image RI, and the right image RM of the vehicle on the display 310 only when a set condition is met. For example, the display controller 340 or 340′ may display the left neighborhood image LM, the front image FI, the rear image RI, and the right image RM of the vehicle on the display 310 when a driving velocity of the vehicle reduces or a rear gear operates for parking the vehicle.

In another example, the display controller 340 or 340′ may allow one of or a plurality of the left neighborhood image LM, the front image FI, the rear image RI, and the right image RM of the vehicle to match one region or a plurality of regions of the display 310 and display the same only when a set condition is met. That is, none of the left neighborhood image LM, the front image FI, the rear image RI, and the right image RM of the vehicle may be displayed in at least one of the first divided region DA1, second divided region DA2, third divided region DA3, or fourth divided region DA4.

FIG. 22B is a view illustrating an embodiment of FIG. 22A. Referring to FIG. 22B, the display system 300 is illustrated. The display 310 of the display system 300 is divided into the first divided region DA1, the second divided region DA2, the third divided region DA3, and the fourth divided region DA4 as illustrated in FIG. 21. In this case, boundary lines dividing the first divided region DA1, the second divided region DA2, the third divided region DA3, and the fourth divided region DA4 may be virtual lines, not lines actually dividing the display 310.

A left neighborhood image LM, a front image FI, a rear image RI, and a right image RM of the vehicle may be disposed in the first divided region DA1, the second divided region DA2, the third divided region DA3, and the fourth divided region DA4. For example, the left neighborhood image LM of the vehicle may be displayed in the first divided region DA1, the rear image RI of the vehicle may be displayed in the second divided region DA2 and the third divided region DA3, and the right image RM of the vehicle may be displayed in the fourth divided region DA4.

Unlike FIG. 22A, FIG. 22B illustrates displaying one image in two divided regions instead of displaying one image in one divided region. For example, the rear image RI of the vehicle may be displayed in the second divided region DA2 and the third divided region DA3. For example, one image may be displayed in a plurality of divided regions by the location matching unit 341′ according to an embodiment.

According to an embodiment, the front image FI of the vehicle may be displayed in one of the second divided region DA2 and the third divided region DA3 such that the front image FI of the vehicle overlaps the rear image RI of the vehicle. For example, the rear image RI of the vehicle is displayed as main information in the second divided region DA2 and the third divided region DA3 via the overlapping controller 343′, and the front image FI of the vehicle may be displayed less than the rear image RI of the vehicle at a place that overlaps the rear image RI of the vehicle.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The controllers, units, and other processing features of the embodiments disclosed herein may be implemented in logic which, for example, may include hardware, software, or both. When implemented at least partially in hardware, the controllers, units, and other processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controllers, units, and other processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

In accordance with one or more of the aforementioned embodiments, a display system includes a display inside a vehicle so that a vehicle user, for example, a vehicle driver, may easily obtain information. The image information controller may receive image information from inside the vehicle or an external capturing member, the location controller may divide a region of the display into one or more divided regions, and the display controller may display image information to correspond to the divided regions. As a result, a user may easily understand neighboring or adjacent information or internal information of the vehicle via the display.

Also, according to at least one embodiment, the display system 300 may improve user convenience by displaying image information of the neighboring or adjacent information or internal information of the vehicle via the display only when a set condition is met.

Also, according to at least one embodiment, a main image corresponding to a certain circumstance may be magnified and recognized by allowing one image information to correspond to a plurality of regions. A user's information recognition ability may improve by displaying a small sub image, and a user convenience and safety may improve through this.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the embodiments set forth in the claims.

What is claimed is:

1. A display system for a vehicle, the system comprising:
a display inside the vehicle to display one or more information;
a driver to drive the display to move the display;
a detector to detect a change of a provided region corresponding to an area recognized by a user as the display is moved by the driver; and
a display controller to convert a shape of an information region in the display depending on the change of the provided region detected by the detector.

2. The system as claimed in claim 1, wherein:
at least one region of the display is received in one area inside the vehicle, and
the display is to move in a direction facing outside from inside the area inside the vehicle or a direction facing inside from outside of the area.

3. The system as claimed in claim 1, wherein the area includes a dashboard.

4. The system as claimed in claim 1, wherein the driver includes:
a velocity related controller to drive the display depending on a driving velocity of the vehicle.

5. The system as claimed in claim 1, wherein the driver includes a selective input controller to drive the display by recognizing a user selection input.

6. The system as claimed in claim 1, wherein the detector includes:
a detector to detect the provided region based on driving information from the driver.

7. The system as claimed in claim 1, wherein the detector includes:
a detector to detect the provided region based on a reference point of the display or based on a comparison point adjacent to the reference point.

8. The system as claimed in claim 1, wherein the display controller includes a converter to convert a size of the information region on the display.

9. The system as claimed in claim 1, wherein the display controller includes a converter to convert a shape of the information region on the display.

10. A display system for a vehicle, the system comprising:
a display inside the vehicle to display at least a first information region;
a recognition controller to recognize a user manipulation for the first information region on the display;
a conversion controller to convert the first information region to a second information region depending on recognition of the recognition controller;
a location controller to determine a second information region display location to display the second information region; and
a conversion display controller to display the second information region at the second information region display location.

11. The system as claimed in claim 10, wherein the recognition controller includes a direction manipulation recognizer to recognize a direction of manipulation at the display based on a user manipulation for the first information region.

12. The system as claimed in claim 10, wherein the recognition controller includes a multi-manipulation recognizer to recognize a user multi-manipulation for the first information region of the display.

13. The system as claimed in claim 10, wherein the conversion controller is to generate the second information region to have a shape corresponding to one of divided first information regions, when converting the first information region to the second information region.

14. The system as claimed in claim 10, wherein the location controller is to determine the second information region display location to correspond to a direction of the user manipulation.

15. The system as claimed in claim 10, wherein the display is to create and display an additional information region separated from the second information region.

16. The system as claimed in claim 10, wherein information of the first information region and the second information region includes same content or a same type of content.

17. A display device for a vehicle, the display device comprising:
a display inside the vehicle to display an image;
an image information controller to receive image information from inside the vehicle or an external capturing source;
a location controller to define the display as a plurality of divided regions to display the image information on the display; and
a display controller to allow the image information to match a divided region of the display and to display the image information.

18. The display device as claimed in claim 17, wherein the display controller includes:
a location matcher to allow the image information received from the image information controller to match and correspond to the divided region of the display divided by the location controller; and
a shape matcher to convert a shape of the image information to correspond to the divided region when displaying the image information according to the location matcher.

19. The display device as claimed in claim 17, wherein the display controller includes an overlapping controller to display one or more image information to overlaps other image information.

20. The display device as claimed in claim 19, wherein the overlapping controller is to display one main image information to correspond to divided regions and display sub-image information to overlap the main image information that is less than the main image information.
